(19) United States
(12) Patent Application Publication
(10) Pub. No.: US 2017/0250426 A1
(43) Pub. Date: Aug. 31, 2017

(54) POWER GENERATION STOPPING METHOD FOR FUEL CELL SYSTEM AND FUEL CELL SYSTEM

(71) Applicant: HONDA MOTOR CO., LTD., Tokyo (JP)

(72) Inventors: Masakazu HAMACHI, Wako (JP); Hiroaki OTA, Wako (JP); Shinya WATANABE, Wako (JP); Takuya TAMURA, Wako (JP)

(73) Assignee: HONDA MOTOR CO., LTD., Tokyo (JP)

(21) Appl. No.: 15/434,062

(22) Filed: Feb. 16, 2017

(30) Foreign Application Priority Data
Feb. 29, 2016 (JP) 2016-036539

(51) Int. Cl. H01M 8/04955; H01M 8/1004; H01M 8/04228; H01M 8/04858; H01M 8/0432; H01M 8/04223; H01M 8/1007; H01M 8/04701

(52) U.S. Cl. CPC H01M 8/04955; H01M 8/1007; H01M 8/1004; H01M 8/04723; H01M 8/04932; H01M 8/04358; H01M 8/04253; H01M 8/04228; H01M 2250/20; H01M 2300/0082; H01M 2008/1095

(57) ABSTRACT

A power generation stopping method for a fuel cell system including a fuel cell, includes continuing generating electric power by the fuel cell via electrochemical reaction between fuel gas and oxidant gas during a post running period after the fuel cell system is ordered to stop. A coolant is supplied at a first flow rate to the fuel cell during the post running period until temperature of the fuel cell reaches a threshold temperature. A coolant is supplied to the fuel cell at a second flow rate larger than the first flow rate during the post running period after the temperature of the fuel cell has reached the threshold temperature.

### CROSS-REFERENCE TO RELATED APPLICATIONS

The present application claims priority under 35 U.S.C. §119 to Japanese Patent Application No. 2016-036539, filed Feb. 29, 2016, entitled “POWER GENERATION STOPPING METHOD IN FUEL CELL SYSTEM.” The contents of this application are incorporated herein by reference in their entirety.

### BACKGROUND

1. Field

The present disclosure relates to a power generation stopping method for a fuel cell system and a fuel cell system.

2. Description of the Related Art

For example, a solid polymer electrolyte fuel cell includes a membrane electrode assembly (MEA) in which an anode electrode is disposed at one surface of an electrolyte membrane made of a polymer ion exchange membrane and a cathode electrode is disposed at the other surface of the electrolyte membrane, respectively. The membrane electrode assembly is sandwiched between separators to constitute a power generation cell (unit cell). Usually, a predetermined number of power generation cells are stacked successively to constitute, e.g., a vehicle-mounted fuel cell stack that is installed in a fuel cell vehicle (such as a fuel cell electric car).

In the above-mentioned type of fuel cell, because power generation (operation) is performed by electrochemical reaction between hydrogen gas (fuel gas) and oxygen gas (oxidant gas), water produced with the reaction generates in the cathode side. On the other hand, the produced water passes through an electrolyte membrane (by back diffusion), and moisture is present in the anode side. Accordingly, when the fuel cell stack is stopped in a low-temperature state before its temperature is raised appropriately, there is a possibility that startup performance may fall at next startup, and that water in the fuel cell stack and water in accessories may be frozen.

In view of the above point, a method of stopping a fuel cell system is proposed as disclosed in Japanese Unexamined Patent Application Publication No. 2003-151601, for example. According to the proposed stopping method, at the time of stopping the system, cooling performance of a cooling device for the fuel cell is reduced, and the fuel cell is continuously operated to raise the temperature of the fuel cell by utilizing heat generated with the electrochemical reaction. After the temperature of the fuel cell has risen, the operation of the fuel cell is stopped.

### SUMMARY

According to a first aspect of the present invention, a power generation stopping method for a fuel cell system including a fuel cell, includes continuing generating electric power by the fuel cell via electrochemical reaction between fuel gas and oxidant gas during a post running period after the fuel cell system is ordered to stop. A coolant is supplied at a first flow rate to the fuel cell during the post running period until temperature of the fuel cell reaches a threshold temperature. A coolant is supplied to the fuel cell at a second flow rate larger than the first flow rate during the post running period after the temperature of the fuel cell has reached the threshold temperature.

According to a second aspect of the present invention, a fuel cell system includes a fuel cell, a fuel gas supplier, an oxidant gas supplier, a coolant supplier, and circuitry. The fuel cell generates electric power via electrochemical reaction between fuel gas and oxidant gas. The fuel gas supplier supplies the fuel gas into the fuel cell. The oxidant gas supplier supplies the oxidant gas into the fuel cell. The coolant supplier supplies a coolant into the fuel cell. The circuitry is configured to control the fuel cell to continue generating the electric power during a post running period after the fuel cell system is ordered to stop. The circuitry is configured to control the coolant supplier to supply the coolant at a first flow rate to the fuel cell during the post running period until temperature of the fuel cell reaches a threshold temperature. The circuitry is configured to control the coolant supplier to supply the coolant to the fuel cell at a second flow rate larger than the first flow rate during the post running period after the temperature of the fuel cell has reached the threshold temperature.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings.

FIG. 1 is a schematic explanatory view of a fuel cell system to which a power generation stopping method according to an embodiment of the present application is applied.

FIG. 2 is a time chart referenced to explain the power generation stopping method.

FIG. 3 is a flowchart to explain the power generation stopping method.

FIG. 4 is a graph depicting relations between stack temperature and cathode humidity depending on the number of rotations of a water pump.

FIG. 5 is a time chart depicting relations among water temperature, impedance, and coolant flow rate.

FIG. 6 is a time chart referenced to explain a relation between thawing time and coolant flow rate.

### DESCRIPTION OF THE EMBODIMENTS

The embodiments will now be described with reference to the accompanying drawings, wherein like reference numerals designate corresponding or identical elements throughout the various drawings.

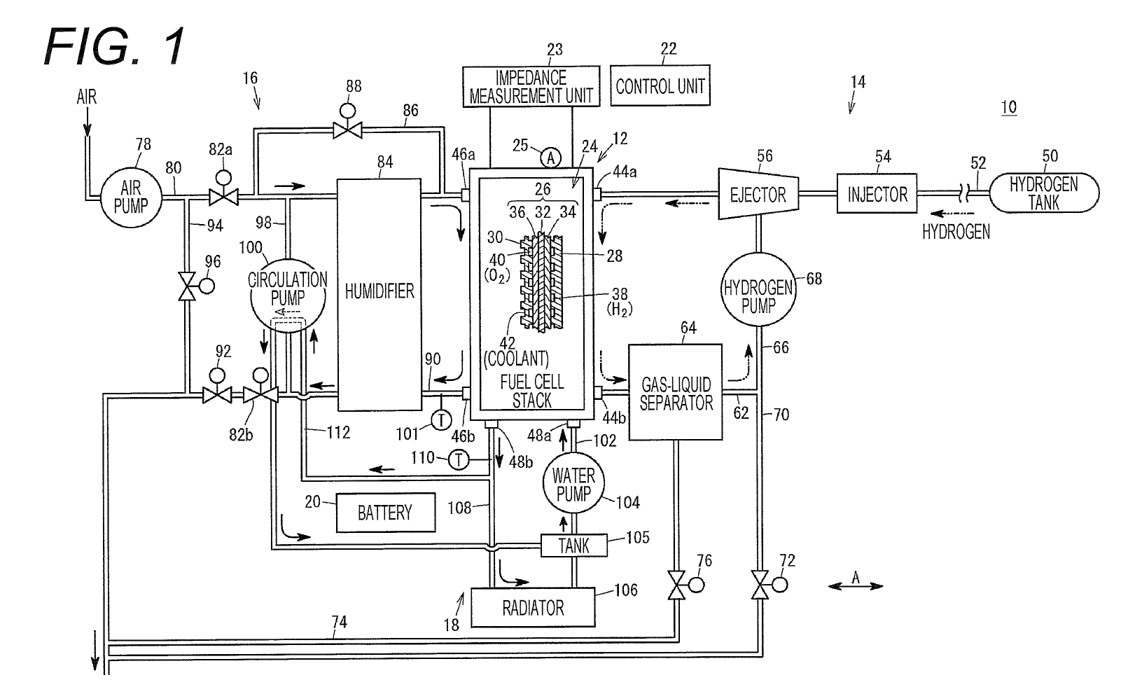

As illustrated in FIG. 1, a fuel cell system 10 to which a power generation stopping method according to an embodiment of the present application is installed in a fuel cell vehicle (not illustrated), such as a fuel cell electric car.

The fuel cell system 10 includes a fuel cell stack 12. The fuel cell stack 12 is connected with a fuel gas supply device 14 that supplies, for example, hydrogen gas as fuel gas, an oxidant gas supply device 16 that supplies, for example, air as oxidant gas, and a coolant supply device 18 that supplies a coolant.

The fuel cell system 10 further includes a battery 20 that is an energy storage device, a control unit (ECU =electric control unit) 22 that is a system controller, and an impedance measurement unit 23. The impedance measurement unit 23 estimates a humidity or a resistance on the basis of an impedance value that is measured from a membrane electrode assembly 26 (described later), and the control unit 22 measures a water content of the membrane electrode assembly 26 on the basis of the estimated value. A current sensor 25 for detecting a current value obtained with power generation is attached to the fuel cell stack 12, and the detected current value is sent to the control unit 22.

The fuel cell stack 12 includes a plurality of power generation cells 24 stacked successively in a horizontal direction or a vertical direction. Each of the power generation cells 24 includes the membrane electrode assembly 26 sandwiched between a first separator 28 and a second separator 30. The first separator 28 and the second separator 30 are each constituted by a metal separator or a carbon separator.

The membrane electrode assembly 26 includes a solid polymer electrolyte membrane 32 that is, for example, a thin film made of a perfluorosulfonic acid and containing moisture, an anode electrode 34, and a cathode electrode 36, both the electrodes 34 and 36 sandwiching the solid polymer electrolyte membrane 32 therebetween. The solid polymer electrolyte membrane 32 may be made of a fluorine-based electrolyte or a HC (hydrocarbon)-based electrolyte.

The first separator 28 provides, between itself and the membrane electrode assembly 26, a hydrogen gas flow passage 38 through which hydrogen gas is supplied to the anode electrode 34. The second separator 30 provides, between itself and the membrane electrode assembly 26, an air flow passage 40 through which air is supplied to the cathode electrode 36. A coolant flow passage 42 allowing a coolant to flow therethrough is disposed between the first separator 28 and the second separator 30 adjacent to each other.

The fuel cell stack 12 has a hydrogen gas inlet 44a, a hydrogen gas outlet 44b, an air inlet 46a, an air outlet 46b, a coolant inlet 48a, and a coolant outlet 48b. The hydrogen gas inlet 44a penetrates through each power generation cell 24 in the stacking direction, and it is communicated with the supply side of the hydrogen gas flow passage 38. The hydrogen gas outlet 44b penetrates through each power generation cell 24 in the stacking direction, and it is communicated with the discharge side of the hydrogen gas flow passage 38. An anode flow passage is constituted by the hydrogen gas flow passage 38, the hydrogen gas inlet 44a, and the hydrogen gas outlet 44b.

The air inlet 46a penetrates through each power generation cell 24 in the stacking direction, and it is communicated with the supply side of the air flow passage 40. The air outlet 46b penetrates through each power generation cell 24 in the stacking direction, and it is communicated with the discharge side of the air flow passage 40. A cathode flow passage is constituted by the air flow passage 40, the air inlet 46a, and the air outlet 46b.

The coolant inlet 48a penetrates through each power generation cell 24 in the stacking direction, and it is communicated with the supply side of the coolant flow passage 42. The coolant outlet 48b penetrates through each power generation cell 24 in the stacking direction, and it is communicated with the discharge side of the coolant flow passage 42.

The fuel gas supply device 14 includes a hydrogen tank 50 that stores hydrogen under high pressure. The hydrogen tank 50 is communicated with the hydrogen gas inlet 44a of the fuel cell stack 12 through a hydrogen gas supply passage 52. The hydrogen gas supply passage 52 supplies the hydrogen gas to the fuel cell stack 12. An injector 54 and an ejector 56 are disposed in the hydrogen gas supply passage 52 in series.

A hydrogen gas discharge passage (off-gas line) 62 is communicated with the hydrogen gas outlet 44b of the fuel cell stack 12. The hydrogen gas discharge passage 62 guides waste hydrogen gas, at least a part of which has been used by the anode electrode 34, to be discharged from the fuel cell stack 12. A gas-liquid separator 64 is connected to the hydrogen gas discharge passage 62. The ejector 56 is also connected to the hydrogen gas discharge passage 62 through a hydrogen circulation flow passage 66 that is branched from the hydrogen gas discharge passage 62 at a position downstream of the gas-liquid separator 64. A hydrogen pump 68 is disposed in the hydrogen circulation flow passage 66. At the startup, particularly, the hydrogen gas pump 68 circulates the waste hydrogen gas, which has been discharged to the hydrogen gas discharge passage 62, to the hydrogen gas supply passage 52 through the hydrogen circulation flow passage 66.

One end of a purge flow passage 70 is communicated with the downstream side of the hydrogen gas discharge passage 62, and a purge valve 72 is disposed midway the purge flow passage 70. One end of a waste water flow passage 74 through which a fluid mainly containing liquid components is discharged is connected to a bottom portion of the gas-liquid separator 64. A drain valve 76 is disposed midway the waste water flow passage 74.

The oxidant gas supply device 16 includes an air pump 78 that compresses air taken from the atmosphere and that supplies the compressed air. The air pump 78 is disposed in an air supply passage 80. The air supply passage 80 supplies the air to the fuel cell stack 12.

In the air supply passage 80, a supply-side on-off valve (inlet sealing valve) 82a and a humidifier 84 are disposed downstream of the air pump 78. The air supply passage 80 is communicated with the air inlet 46a of the fuel cell stack 12. A bypass supply passage 86 is connected to the air supply passage 80 in a bypassing relation to the humidifier 84. A BP flow rate adjustment valve 88 (bypass valve) is disposed in the bypass supply passage 86 to adjust a flow rate of air flowing through the bypass supply passage 86.

An air discharge passage 90 is communicated with the air outlet 46b of the fuel cell stack 12. The humidifier 84 for exchanging moisture and heat between the supplied air and the discharged air, a discharge-side on-off valve (outlet sealing valve) 82b, and a back pressure valve 92 are disposed in the air discharge passage 90. The air discharge passage 90 discharges, from the fuel cell stack 12, waste air at least a part of which has been used by the cathode electrode 36. The other end of the purge flow passage 70 and the other end of the waste water flow passage 74 are connected to the downstream side of the air discharge passage 90, thus constituting a dilution section.

Opposite ends of a bypass flow passage 94 is communicated with the air supply passage 80 and the air discharge passage 90 at positions upstream of the supply-side on-off valve 82a and downstream of both the discharge-side on-off valve 82b and the back pressure valve 92, respectively. A BP (bypass) flow rate adjustment valve 96 is disposed in the bypass flow passage 94 to adjust a flow rate of air flowing through the bypass flow passage 94.

An air circulation flow passage 98 is communicated with the air supply passage 80 and the air discharge passage 90 at positions downstream of the supply-side on-off valve 82a and upstream of the discharge-side on-off valve 82b, respectively. A circulation pump 100 is disposed in the air circulation flow passage 98. The circulation pump 100 circulates the waste air, which has been discharged to the air discharge passage 90, to the air supply passage 80 through the air circulation flow passage 98. An air temperature sensor 101 for detecting a temperature of the discharged air (i.e., a stack temperature), which is discharged from the air outlet 46b of the fuel cell stack 12, is disposed in the air discharge passage 90.

The coolant supply device 18 includes a coolant supply passage 102 that is connected to the coolant inlet 48a of the fuel cell stack 12. A water pump 104 and a tank 105 are disposed midway the coolant supply passage 102. The coolant supply passage 102 is connected to a radiator 106, and a coolant discharge passage 108 in communication with the coolant outlet 48b is also connected to the radiator 106. A coolant temperature sensor 110 for detecting a coolant outlet temperature is disposed in the coolant discharge passage 108.

The coolant supply device 18 includes a coolant circulation passage 112 through which the coolant discharged from the coolant outlet 48b of the fuel cell stack 12 is guided to flow through equipment that constitutes the oxidant gas supply device 16 and that is freezable, e.g., the circulation pump 100 and the discharge-side on-off valve 82b. The inlet side of the coolant circulation passage 112 is communicated with the coolant discharge passage 108, and the outlet side of the coolant circulation passage 112 is communicated with the tank 105. It is to be noted that the coolant circulation passage 112 may be designed in a way of causing the coolant to flow to the supply-side on-off valve 82a as well.

The operation of the fuel cell system 10 thus constituted will be described below.

In the fuel gas supply device 14, the hydrogen gas is supplied from the hydrogen tank 50 to the hydrogen gas supply passage 52. The hydrogen gas is then supplied to the hydrogen gas inlet 44a of the fuel cell stack 12 through both the injector 54 and the ejector 56. The hydrogen gas is introduced to the hydrogen gas flow passage 38 from the hydrogen gas inlet 44a, and is supplied to the anode electrode 34 of the membrane electrode assembly 26 in the course of moving along the hydrogen gas flow passage 38.

In the oxidant gas supply device 16, air is delivered to the air supply passage 80 with rotation of the air pump 78. The air is humidified while passing through the humidifier 84, and is supplied to the air inlet 46a of the fuel cell stack 12. Furthermore, the air is introduced to the air flow passage 40 from the air inlet 46a, and is supplied to the cathode electrode 36 of the membrane electrode assembly 26 in the course of moving along the air flow passage 40.

Thus, in the membrane electrode assembly 26, the hydrogen gas supplied to the anode electrode 34 and oxygen in the air supplied to the cathode electrode 36 are consumed by the electrochemical reaction in catalyst layers of the electrodes, whereby electric power is generated.

In the coolant supply device 18, a coolant, e.g., pure water, ethylene glycol, or oil, is supplied to the coolant inlet 48a of the fuel cell stack 12 from the coolant supply passage 102 by the action of the water pump 104. After flowing along the coolant flow passage 42 to cool the power generation cells 24, the coolant is discharged to the coolant discharge passage 108 through the coolant outlet 48b.

The hydrogen gas having been supplied to the anode electrode 34 and having been partly consumed by the anode electrode 34 (i.e., the waste hydrogen gas) is discharged to the hydrogen gas discharge passage 62 through the hydrogen gas outlet 44b. The waste hydrogen gas is introduced to the hydrogen circulation flow passage 66 from the hydrogen gas discharge passage 62, and is circulated to the hydrogen gas supply passage 52 by the sucking action of the ejector 56. The waste hydrogen gas discharged to the hydrogen gas discharge passage 62 is discharged (purged), as required, to the outside with opening of the purge valve 72.

Likewise, the air having been supplied to the cathode electrode 36 and having been partly consumed by the cathode electrode 36 (i.e., the waste air) is discharged to the air discharge passage 90 through the air outlet 46b. The waste air is passed through the humidifier 84 to humidify fresh air supplied from the air supply passage 80. After pressure of the waste air is adjusted to the setting pressure of the back pressure valve 92, the waste air is discharged to the dilution section. The air discharged to the air discharge passage 90 is circulated, as required, to the air supply passage 80 through the air circulation passage 98 by the action of the circulation pump 100.

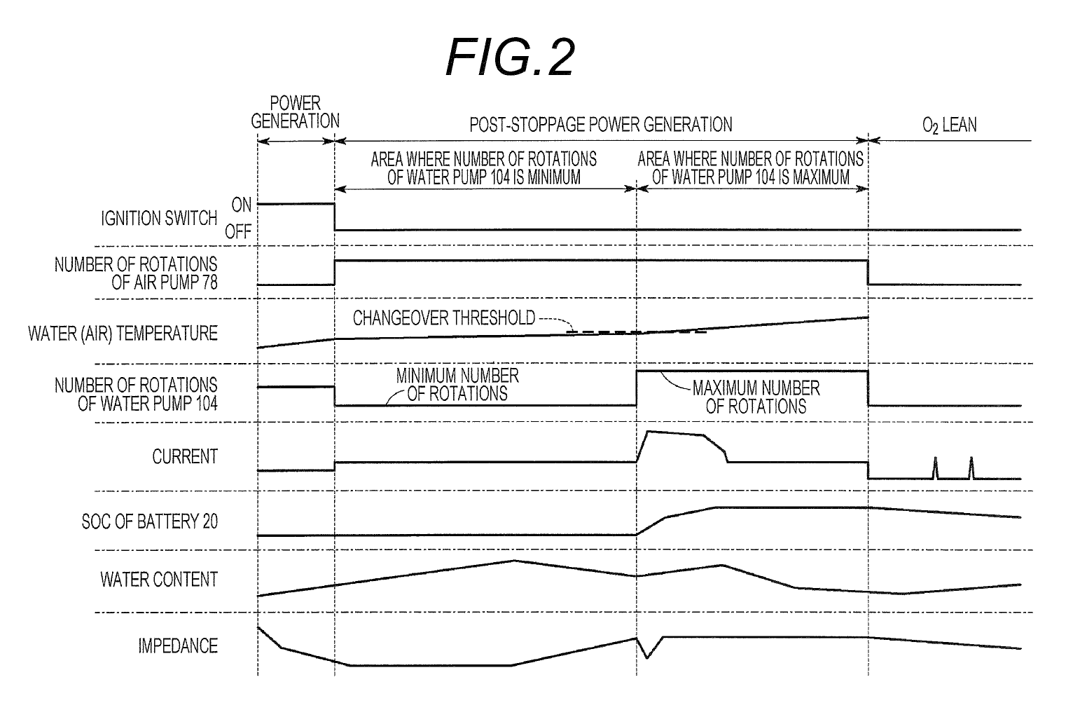

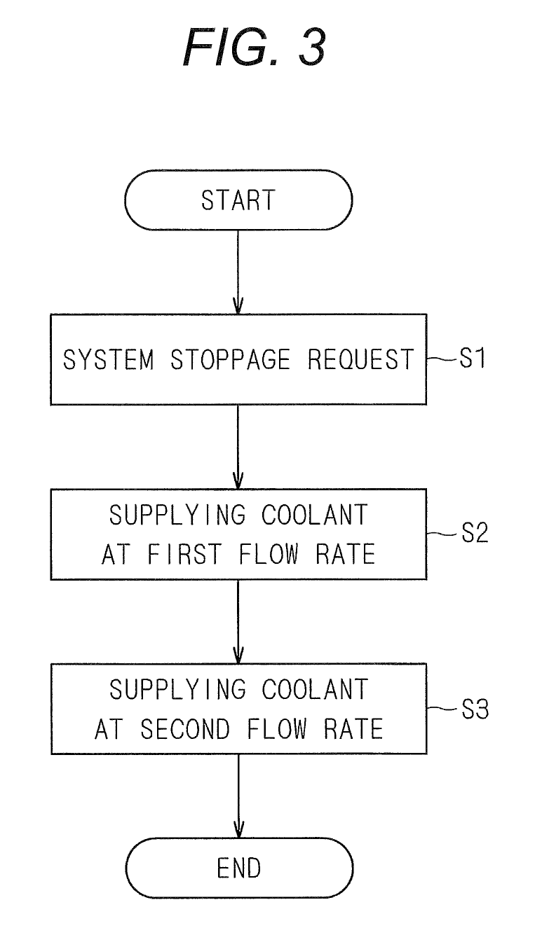

The power generation stopping method in the fuel cell system 10, according to the embodiment, will be described below with reference to a time chart illustrated in FIG. 2 and a flowchart illustrated in FIG. 3.

In FIG. 2, at the top of a vertical axis, there is indicated an on-off switching timing of an ignition switch that is used, by way of example, to input a startup commence signal to the control unit 22. Furthermore, the number of rotations of the air pump 78, the water temperature detected by the coolant temperature sensor 110, the number of rotations of the water pump 104, the current value detected by the current sensor 25, the SOC (state of charge) of the battery 20, and the water content and the impedance value of the fuel cell stack 12 are successively indicated along the vertical axis. The water temperature detected by the coolant temperature sensor 110 may be replaced with the air temperature detected by the air temperature sensor 101.

When the ignition switch is turned off and a system stoppage request is issued after ordinary power generation by the fuel cell system 10 (step S1 in FIG. 3), the fuel cell system 10 shifts to a post-stoppage power generation process. Thus, the number of rotations of the air pump 78 is increased, the number of rotations of the water pump 104 is set to a minimum number of rotations, and the flow rate of the coolant supplied to the fuel cell stack 12 is controlled to a first coolant flow rate.

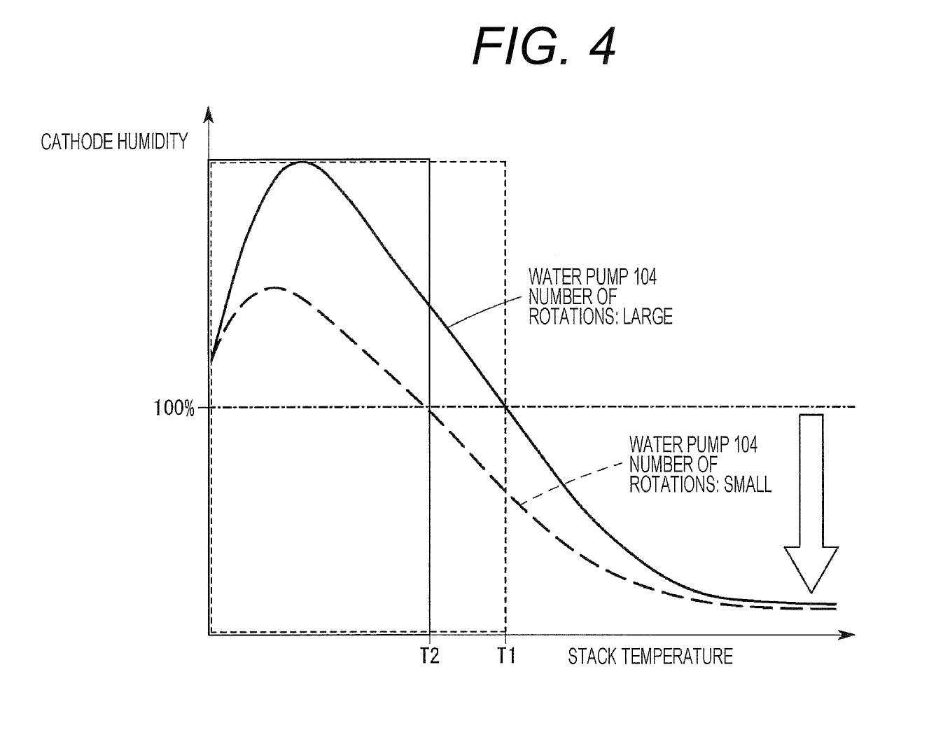

The first coolant flow rate is a flow rate at which the cathode humidity in the fuel cell stack 12 (i.e., the humidity on the side close to the cathode electrode 36) can be lowered(step S2 in FIG. 3). As depicted in FIG. 4, as the number of rotations of the water pump 104 increases, the cathode humidity rises with an increase of the coolant flow rate, and a stack temperature T1 at which the cathode humidity can be lowered to a certain level also rises. On the other hand, as the number of rotations of the water pump 104 decreases, the cathode humidity lowers with a decrease of the coolant flow rate, and a stack temperature T2 at which the cathode humidity can be lowered to the certain level also lowers.

Accordingly, the first coolant flow rate is set by controlling the number of rotations of the water pump 104 to the minimum number of rotations (e.g., about 1000 rpm). In other words, in a process of raising the temperature of the fuel cell stack 12, the coolant flow rate is selected as a flow rate at which the cathode humidity is more apt to transit from an excessively wet state to a dry state.

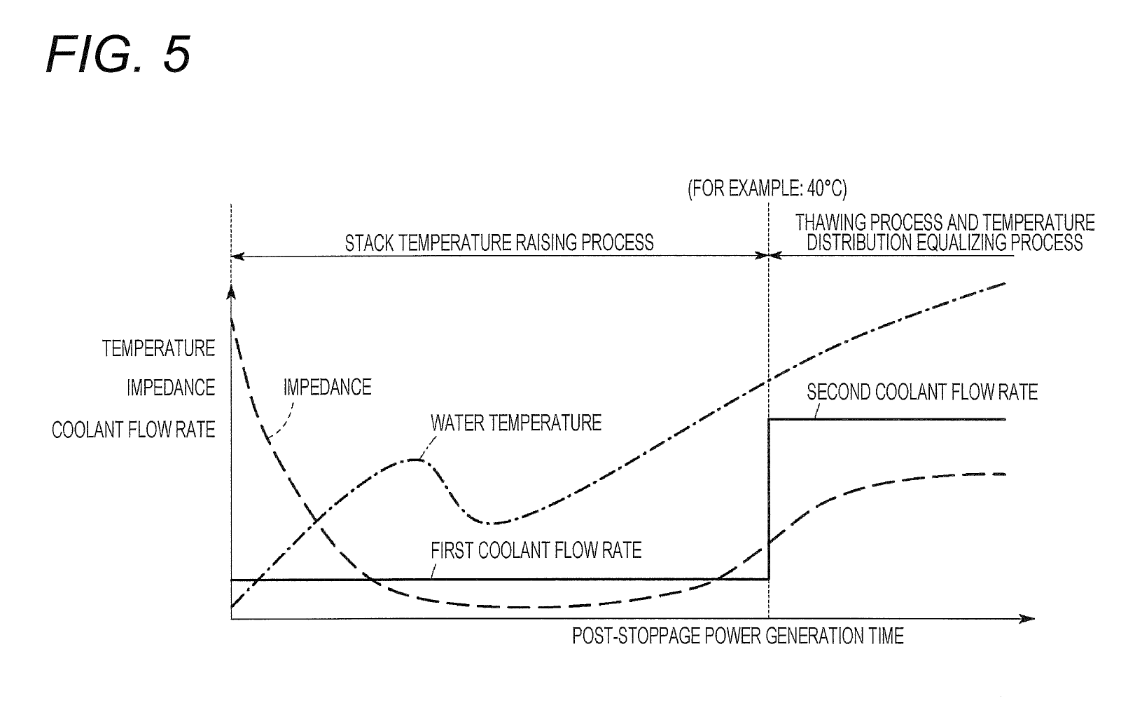

As depicted in FIG. 5, when the first coolant flow rate is set, the water temperature detected at the coolant outlet 48b of the fuel cell stack 12 rises, and the impedance value lowers; namely the water content increases. The detected water temperature temporarily lowers in the course of continuous rising. This is because the low-temperature coolant remaining in the piping of a coolant system is detected at that timing.

As depicted in FIG. 2, when the water temperature at the coolant outlet 48b of the fuel cell stack 12 rises to a predetermined temperature (e.g., 40° C.) or thereabout, the number of rotations of the water pump 104 is changed over from the minimum number of rotations (e.g., about 1000 rpm) to a maximum number of rotations (e.g., about 4000 rpm).

As a result, the flow rate of the coolant supplied to the fuel cell stack 12 is controlled to increase from the first coolant flow rate to a second coolant flow rate(step S3 in FIG. 3), thus shifting to a thawing process and a temperature distribution equalizing process (see FIG. 5). If the current value is increased before the water temperature in the fuel cell stack 12 has risen to the predetermined temperature, there would be a possibility that a large amount of water is produced and an excessively long time is taken until the impedance value increases sufficiently.

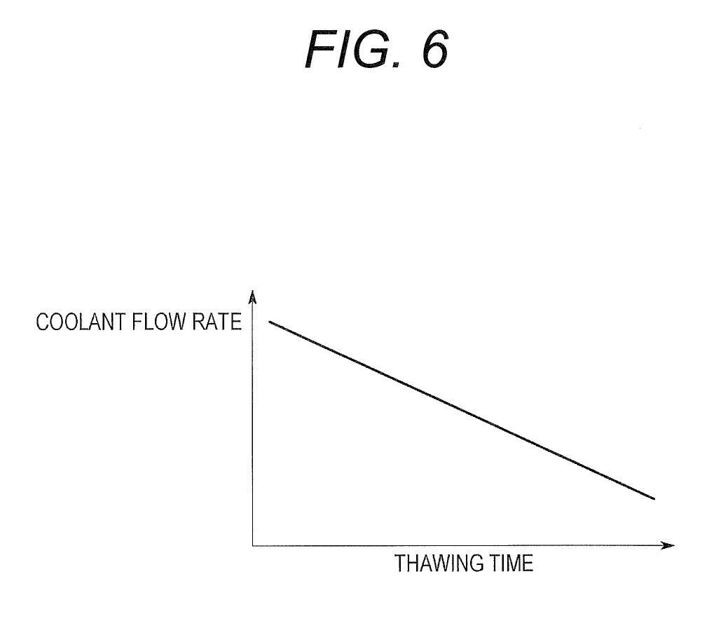

Here, as depicted in FIG. 6, the thawing time depends on the coolant flow rate, and the coolant flow rate is preferably increased to shorten the thawing time. On the other hand, the thawing time depends on the temperature of the coolant as well. It is hence desired to suppress the coolant flow rate when the temperature of the coolant is low, and to maximally increase the coolant flow rate after rising of the temperature.

In the coolant supply device 18, as illustrated in FIG. 1, a part of the coolant (warm water) discharged in an increased flow rate to the coolant discharge passage 108 from the coolant outlet 48b of the fuel cell stack 12 is supplied to the coolant circulation passage 112. After flowing through the coolant circulation passage 112, the coolant flows through the circulation pump 100 and the discharge-side on-off valve 82b, thereby thawing the circulation pump 100 and the discharge-side on-off valve 82b.

Furthermore, the flow rate of the coolant supplied to the fuel cell stack 12 is controlled to be set to the second coolant flow rate that is larger than the first coolant flow rate. Accordingly, the coolant is supplied as warm water to the fuel cell stack 12 at an increased flow rate.

After the post-stoppage power generation process has been performed for a predetermined time, the fuel cell system 10 shifts to an O₂ lean process, for example. In the O₂ lean process, the power generation of the fuel cell stack 12 is performed by employing air that is supplied in a circulating manner with rotation of the circulation pump 100 in a state where the supply-side on-off valve 82a and the discharge-side on-off valve 82b are both closed, by way of example, as illustrated in FIG. 1. As a result, oxygen in the air remaining inside the fuel cell stack 12 is consumed by reacting with the hydrogen gas, and an environment in which a nitrogen concentration is relatively high, i.e., an environment in which an oxygen concentration is relatively low (O₂ lean environment), is obtained in the cathode flow passage in the fuel cell stack 12. Control for stopping the fuel cell system 10 is thus completed.

According to the embodiment, in a first stage, the coolant set at the first coolant flow rate, which is a relatively low flow rate, is supplied to the fuel cell stack 12. Therefore, a temperature difference is more apt to occur in the electrode surface of each power generation cell 24, and the temperature of the fuel cell stack 12 on the side close to the air outlet 46b rises. Thus, on the side close to the cathode electrode 36, generation of dew condensation is suppressed, and the temperature of the power generation cell 24 rises smoothly. In addition, as a result of increasing the drying effect, an increase in amount of the produced water can be suppressed even in the case of drawing the current.

In a subsequent stage, when the temperature of the fuel cell stack 12 reaches the predetermined temperature, the coolant (warm water) set at the second coolant flow rate, which is a relatively high flow rate, is supplied to the fuel cell stack 12. Therefore, the coolant (warm water) can be passed to the circulation pump 100 and the discharge-side on-off valve 82b, which are connected to the coolant circulation passage 112. Moreover, the coolant (warm water) is supplied to the fuel cell stack 12 at the relatively high flow rate. Thus, inside the power generation cell 24, a temperature distribution in the stacking direction is equalized.

Accordingly, an advantageous effect can be obtained particularly in that, even when the fuel cell system 10 is stopped immediately after the low-temperature startup, it is possible to prevent deterioration of the power generation cell 24 and to satisfactorily ensure stability at the next startup with simple control.

Furthermore, according to the embodiment, the coolant supply device 18 causes the coolant, which is discharged from the coolant outlet 48b of the fuel cell stack 12, to flow through equipment that constitutes the oxidant gas supply device 16 and that is freezable. The freezable equipment includes, e.g., the circulation pump 100 and the discharge-side on-off valve 82b both in association with the 02 lean process (the equipment further including the supply-side on-off valve 82a and the back pressure valve 92 as required).

Thus, since the coolant at a temperature having risen after flowing through the fuel cell stack 12 is supplied to the circulation pump 100 and the discharge-side on-off valve 82b, the circulation pump 100 and the discharge-side on-off valve 82b can be thawed promptly. This provides another advantageous effect that the control (e.g., the 02 lean process) for stopping the fuel cell system 10 can be performed appropriately.

The fuel cell system to which the power generation stopping method according to the present application is applied includes a fuel cell, a fuel gas supply device that supplies fuel gas, an oxidant gas supply device that supplies oxidant gas, and a coolant supply device that supplies a coolant. The fuel cell generates electric power by electrochemical reaction between the fuel gas and the oxidant gas.

The power generation stopping method executes a post-stoppage power generation process of continuing the power generation of the fuel cell for a predetermined time after a system stoppage request has been issued. The post-stoppage power generation process includes a step of, during a period until temperature of the fuel cell reaches a predetermined temperature, controlling a flow rate of the coolant supplied to the fuel cell to be set to a first coolant flow rate. The post-stoppage power generation process further includes a step of, after the temperature of the fuel cell stack reached the predetermined temperature, controlling the flow rate of the coolant supplied to the fuel cell to be set to a second coolant flow rate that is larger than the first coolant flow rate.

In the power generation stopping method, preferably, the coolant supply device causes the coolant discharged from a coolant outlet of the fuel cell to flow through equipment that constitutes the oxidant gas supply device and that is freezable.

According to the present application, in a first stage, the coolant set at the first coolant flow rate, which is a relatively low flow rate, is supplied to the fuel cell. Therefore, a temperature difference is more apt to occur in an electrode surface of the fuel cell, and the temperature of the fuel cell on the side close to a gas outlet rises. Hence generation of dew condensation is suppressed, and the temperature of the fuel cell rises smoothly.

In a subsequent stage, when the temperature of the fuel cell reaches the predetermined temperature, the coolant set at the second coolant flow rate, which is a relatively high flow rate, is supplied to the fuel cell. Therefore, the fuel cell is warmed up to a uniform temperature in a stacking direction, and the freezable equipment can be thawed satisfactorily. As a result, even when the fuel cell system is stopped in a low-temperature state, it is possible to prevent deterioration of the fuel cell and to satisfactorily ensure stability at the next startup with simple control.

Obviously, numerous modifications and variations of the present invention are possible in light of the above teachings. It is therefore to be understood that within the scope of the appended claims, the invention may be practiced otherwise than as specifically described herein.

What is claimed is:

1. A power generation stopping method for a fuel cell system including a fuel cell, comprising:
continuing generating electric power by the fuel cell via electrochemical reaction between fuel gas and oxidant gas during a post running period after the fuel cell system is ordered to stop;
supplying a coolant at a first flow rate to the fuel cell during the post running period until temperature of the fuel cell reaches a threshold temperature; and
supplying a coolant to the fuel cell at a second flow rate larger than the first flow rate during the post running period after the temperature of the fuel cell has reached the threshold temperature.

2. The power generation stopping method according to claim 1, wherein a coolant supply device causes the coolant discharged from a coolant outlet of the fuel cell to flow through equipment that constitutes an oxidant gas supply device and that is freezable.

3. A fuel cell system comprising:
a fuel cell to generate electric power via electrochemical reaction between fuel gas and oxidant gas;
a fuel gas supplier to supply the fuel gas into the fuel cell;
an oxidant gas supplier to supply the oxidant gas into the fuel cell;
a coolant supplier to supply a coolant into the fuel cell; and
circuitry configured to
control the fuel cell to continue generating the electric power during a post running period after the fuel cell system is ordered to stop;
control the coolant supplier to supply the coolant at a first flow rate to the fuel cell during the post running period until temperature of the fuel cell reaches a threshold temperature; and
control the coolant supplier to supply the coolant to the fuel cell at a second flow rate larger than the first flow rate during the post running period after the temperature of the fuel cell has reached the threshold temperature.
